(19) United States
(12) Patent Application Publication
(10) Pub. No.: US 2016/0269534 A1
(43) Pub. Date: Sep. 15, 2016

(54) TECHNIQUES TO COMMUNICATE A TEXT MESSAGE TO AN EMERGENCY SERVICE PROVIDER

(71) Applicant: Bandwidth.com, Inc., Raleigh, NC (US)

(72) Inventor: Brad Roldan, Sunnyvale, CA (US)

(21) Appl. No.: 15/164,218

(22) Filed: May 25, 2016

(51) Int. Cl. H04M 1/725; H04W 4/12; H04M 15/00; H04W 4/22

(52) U.S. Cl. CPC H04M 1/72538; H04W 4/22; H04W 4/12; H04M 1/72572; H04M 15/8033

(57) ABSTRACT

Various embodiments are generally directed to an apparatus, method and other techniques for receiving a message to communicate to an emergency service provider from a first messaging application that is not capable of communicating with the emergency service provider and determining whether at least one of a cellular connection and an Internet Protocol (IP) connection is operable to communicate the message to the emergency service provider. Further and in response to determining that at least one of the cellular connection and IP connection is operable, select one of the cellular connection and IP connection to communicate the message, format the message to be compatible for communication via a second messaging application based on the selection, and cause the message to be communicated to the emergency service provider via the second messaging application.

### TECHNICAL FIELD

Embodiments described herein generally relate to techniques to determine an operable connection to communicate a text message to an emergency service provider.

### BACKGROUND

Mobile telephones are sometimes used to communicate with emergency call services, such as Public Safety Answering Points (PSAPs) via a 911 call. However, in some instances, a caller may not be able or willing to speak with a 911 operator. Mobile telephones also enable users to communicate via alternative methods, including text messaging and instant messaging. However, these alternative methods do not always provide adequate access to an emergency 911 system. Embodiments discussed resolve these and other problems.

### BRIEF DESCRIPTION OF THE DRAWINGS

FIG. 1A illustrates an example embodiment of a system.

FIG. 1B illustrates a second example embodiment of a system.

FIG. 2 illustrates an example of a first logic flow.

FIG. 3 illustrates an example of a second logic flow.

FIG. 4A illustrates an example of a first processing flow.

FIG. 4B illustrates an example of a second processing flow.

FIG. 5 illustrates an example of a third logic flow.

FIG. 6 illustrates an exemplary embodiment of a first computing architecture.

### DETAILED DESCRIPTION

Various embodiments may include a system, apparatus, and techniques to include a framework having logic to enable a messaging application to communicate a message to an emergency service provide. The framework may include one or more application programming interfaces (APIs) in the form of libraries capable of interfacing with a messaging application, an operating system, and other components of a device. The framework and logic may perform various functions and operations including receiving a message from a messaging application, determining a network to communicate the message to an emergency service provider, and causing the message to be communicated to the emergency service provider via the selected network, for example.

In some embodiments, the logic may determine whether at least one of a cellular connection and an Internet Protocol (IP) connection is operable to communicate the message to the emergency service provider when determining the network to communicate the text message. For example, embodiments may include retrieving information from one or more of an operating system and transceivers to determine a status of transceivers and network connections. Further and in response to determining that at least one of the cellular connection and IP connection is operable, logic may include selecting one of the cellular connection and IP connection to communicate the message and cause the message to be communicated to the emergency service provider based on the selection. In some instances, the selection may be based on one or more selection criteria and the message may be communicated by a client operation capable of communicating on the selected network, as will be discussed in more detail herein.

Further and in response to determining that no connection is operable to communicate the message, logic may include communicating a bounce back message to a messaging application. The bounce back message may indicate to the originating messaging application that the message cannot be communicated to an emergency service provider because no connections are operable. In some embodiments, the bounce back message may cause a notification to be communicated to a user of the device. These and other details will become more apparent in the following description.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

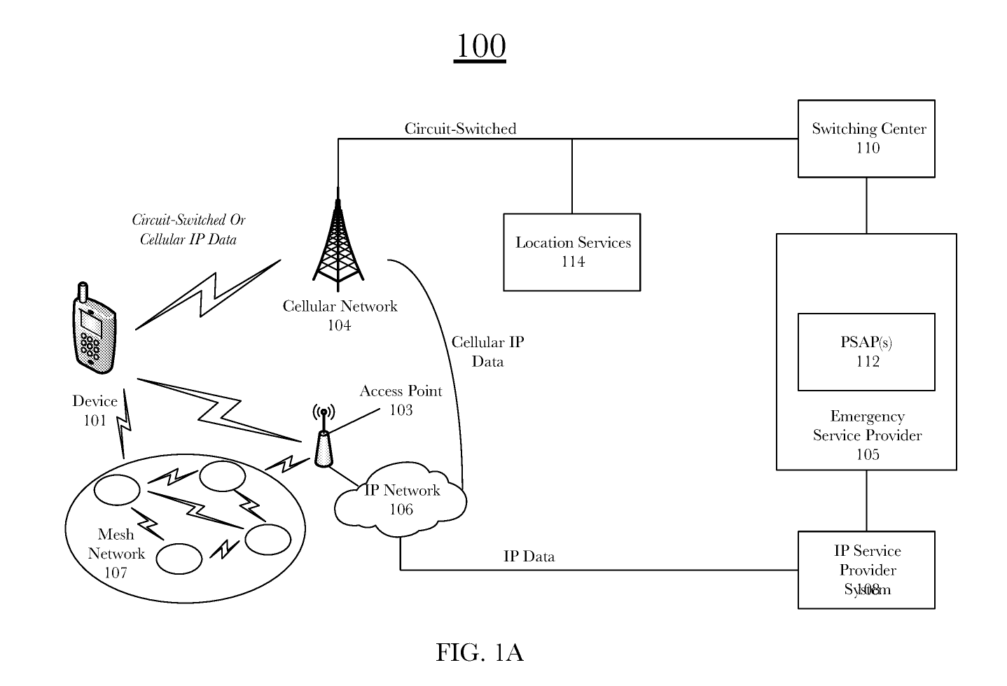

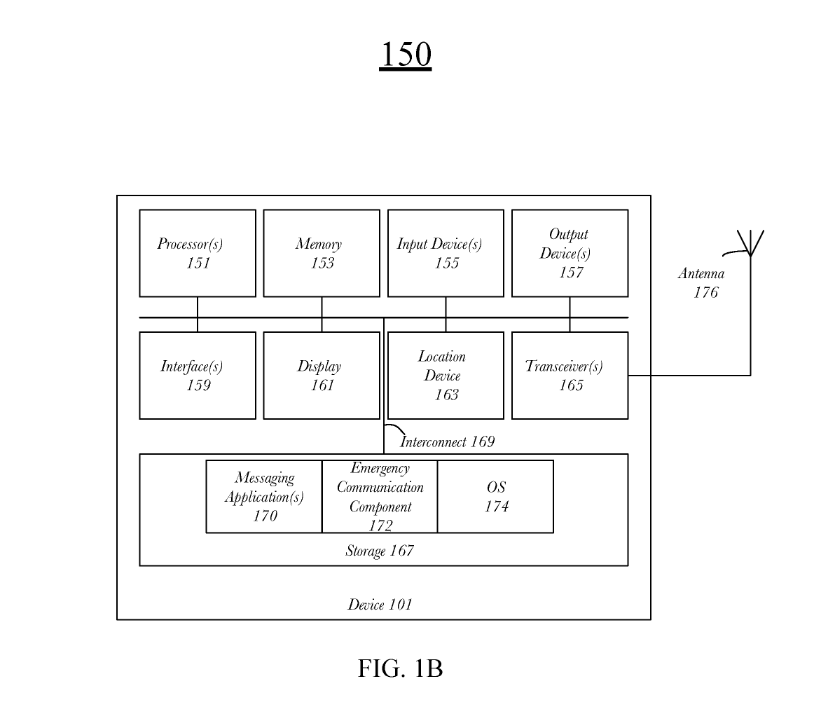

FIG. 1A illustrates an exemplary embodiment of a system 100 in which aspects of the present disclosure may be employed. The system 100 may include a number of devices, systems, and infrastructure to enable one or more devices, such as device 101, to communicate with an emergency service provider 105 including one or more Public Safety Answering Points (PSAPs) 112. These communications include voice communications and text communications. Embodiments discussed herein are particularly directed towards processing and handling of text messages directed to an emergency service provider 105. Note that some embodiments may include communicating one or more text messages in a reverse direction, e.g. from the emergency service provider 105 to the device 101 via the cellular network 104 and/or the IP network 106. These text messages may include emergency broadcast messages to notifying a user of device 101 of an impending emergency, for example.

Further, the system 100 enables communication with an emergency service provider 105 via one or more of a cellular network 104 and an Internet Protocol (IP) network 106. The device 101 may be communicatively coupled with a cellular network 104, an IP network 106, or both and enabled to wirelessly communicate one or more text messages to the emergency service provider 105, for example. Note that the text messages may include Short Message Service (SMS) messages, instant messages (IMs), or any other type of text-based message. For example, embodiments may include determining to communicate to the emergency service provider 105 via the cellular network 104 and formatting the text message into a cellular message format, such as SMS or MMS, for the communication. Similarly, embodiments may include determining to communicate to the emergency service provider 105 via the IP network 106 and formatting the text message into an IP message format or packet-based format, such as an IM message. Embodiments are not limited in this manner.

In some embodiments, the device may communicate cellular IP data including one or more text messages to the emergency service provider 105 via the cellular network 104. The cellular network 104 may include IP networking infrastructure, such as servers, routers, switches, and so forth that may be coupled with the IP network 106. This infrastructure may process the cellular IP data and communicate it to the IP network 106 for further processing and communication to the emergency service provider 105 via the IP network 106.

In embodiments, the cellular network 104 may include infrastructure, such as one or more radio service towers, equipment, and devices to process a wireless communication communicated as radio signals. For example, a radio service tower may receive a wireless communication as one or more wireless radio signals from the device 101. The signals may include information destined from the PSAP 112 and may be processed by receiving circuitry, converters, modulators, and so forth. Further, cellular network 104 may also include devices such as switches, routers, and other circuitry to process the received wireless communications. In some embodiments, the cellular network 104 may be communicatively coupled with or include a switching center 110, such as a mobile switching center (MSC) or a short message service center (SMSC). The switching center 110 may receive and route communications to and from the device 101. In the case of an emergency text message, the switching center 110 may determine which of any number of Public Safety Answering Points (PSAPs) 112 the text message should be routed to based, for example, on the location of the device 101 and a defined geographic area for which a particular PSAP 112 is responsible. Generally speaking, this routing can be based on a set of information maintained in a location service database on a location services system 114 within the switching center 110 or elsewhere and accessible by the switching center 110. In some embodiments, the switching center 110 may request the location from the device 101 itself. The device 101 may provide a location using a location device 163, such as a global position system (GPS) device or based on an IP address.

In some embodiments, the switching center 110 can provide all or a portion of the calling number, e.g., the area code and exchange number (NPA-NXX numbers), to the location service system 114 which can return a set of Vertical and Horizontal (V&H) coordinates for that calling number. The switching center 110 can then use the V&H coordinates to derive a spatial location, e.g., expressed as a latitude and longitude, for the texting or calling number. The spatial location can then be used with a point-in-polygon check by the switching center 110 to determine the particular PSAP 112 that should receive the call or text. In addition, embodiments make use of Local Routing Numbers (LRN) to determine the geographic location of the device 101 who may have ported their number from a different geographic location.

In one example, the device 101 may communicate an emergency text message that can be received by the switching center 110. The switching center 110 may determine a spatial location for the device 101, and once the spatial location of the device 101 has been determined, a PSAP 112 for handling the emergency text can be identified by the switching center 110 based on the determined spatial location for the device 101. For example, identifying the PSAP 112 for handling the emergency text can include the switching center 110 using a point-in-polygon check of the determined spatial location for the texting number against known spatial boundaries for a set of PSAPs 112, e.g., based on longitude and latitude coordinates for each. Once a PSAP 112 for handling the text has been identified, the emergency text message can be routed by the switching center 110 to the identified PSAP 112, which may process the emergency text message and dispatch emergency personnel.

In some embodiments, the system 100 may enable the device 101 to communicate voice communications and text communications via an IP network 106 and provide emergency services via an IP service provider system 108, such as one or more systems including an emergency services (911) gateway operated by Bandwidth.com® Incorporated. The IP network 106 includes any number of networking devices and interconnects to enable device 101 to communicate voice, text, and data communications. For example, the IP network 106 may include access points, such as access point 103, modems, routers, switches, gateways, servers, and so forth to provide an IP network, such as the Internet and/or any other local area or wide area network for sending and receiving calls and text messages including but not limited to emergency text messages, e.g., 911 text messages. The devices of the IP network 106 may enable communication of information in IP packets, for example, over a switched network.

In some embodiments, the system 100 may include a mesh network 107, such as a Bluetooth® mesh network, that may include a number of nodes or devices coupled with each other via one or more communication links. The device 101 may be coupled with the mesh network 107 or be a node within the mesh network and may communicate IP data including one or more text messages via the mesh network 107 to the IP network 106 through access point 103, for example. More specifically, at least one of the nodes of the mesh network 107 may also be coupled with the access point 103. The device 101 may communicate IP data with the mesh network 107 which may be sent to the IP network 106 via the access point 103 and ultimately communicated to the emergency service provider 105. This is just one example configuration, other networking configurations may be employed to communicate IP data.

In embodiments, the system 100 may also include an IP service provider system 108, which may receive and route calls, texts, and other communications to and from the device 101. In the case of an emergency text, the IP service provider system 108 may determine which of any number of PSAPs 112 the emergency text should be routed to based, for example, on the location of the device 101. In some embodiments, the IP service provider system 108 may receive the location from the device 101, or an associated device in a nearby location, such as an access point and VoIP Gateway. The location may be communicated to the IP service provider system 108 with the emergency text message or separately. In some embodiments, the IP service provider system 108 may request the location from the device 101 and the location may be provided by the device 101 in response to the request. The IP service provider system 108 may define a geographic area and select a particular PSAP 112 based on the location information determined by the IP service provider system 108. Generally speaking, the location information may be GPS generated coordinates, an IP address associated with the device 101 or an associated access point, triangulation information determined by the device 101, and so forth. Embodiments are not limited in this manner.

FIG. 1B illustrates an example embodiment of a computing system 150 including a device 101 having a number of components to process and communicate information including text messages destined for an emergency service provider 105. Device 101 may be capable of communicating information via both cellular networks 104 and IP networks 106 including the Internet.

In various embodiments, the device 101 may be embodied as a communication station, a mobile station, an advanced station, a client, a platform, a wireless communication device, a mobile computer, a laptop computer, a notebook computer, a tablet computer, a server computer, a set-top box, a handheld computer, a handheld device, a Personal Digital Assistant (PDA) device, a handheld PDA device, netbook, a mobile telephone, a smart phone, a mobile cellular telephone, and so forth.

The device 101 may include one or more processors 151 which controls one or more operations of the device 101. A processor 151 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. For example, a processor 151 may include a graphical processing unit (GPU) for processing graphical and video information, in various embodiments. In some embodiments, a processor 151 may be connected to and communicate with the other elements of the computing system via an interconnect 169, such as one or more buses, control lines, and data lines.

The device 101 also includes memory 153 which may be one or more of random access memory (RAM), read-only memory (ROM), electrically erasable programmable read-only memory (EEPROM), flash memory, and hard disk memory. The memory 153 is not limited to these memory components. For example, the memory 153 may include a non-transitory computer-readable storage medium. These memory components can store data momentarily, temporarily, or permanently. The memory 153 stores instructions and data for device 101. The memory 153 may also store temporary variables or other intermediate information while a processor 151 is executing instructions.

In some embodiments, the device 101 may also include one or more input device 155 and output devices 157. An input device 155 may include one or more buttons, a keyboard, a keypad, a touchscreen display, a touch sensitive device, a microphone, a camera or any other device used for inputting information into the device 101. An output device 157 may be a speaker, a haptic feedback device, one or more light emitting diodes, a buzzer, a vibration device, and so forth. In some embodiments, the device 101 may include one or more displays 161, such as a liquid crystal display (LCD). In embodiments, these and other devices may be coupled with the device 101 via one or more interfaces 159 and communicate with a processor 151 and memory 153 via interconnect 169, for example. An interface 159 can be a parallel port, IEEE 1394 serial port, a game port, a universal serial bus (USB) port, an infra-red (IR) interface, and so forth.

The device 101 may also include a location device 163 to determine and provide location information, such as a GPS location, an assisted GPS location, a synthetic GPS location, a cell identification location, a triangulation location, an IP address location, an access point location, a user generated location, and so forth. Moreover, the location device 163 may be any type of device to determine location, including a GPS device, one or more inertial sensor devices, one or more proximity sensor devices, a barometer, an ultrasonic device, a Bluetooth® beacon device, one or more terrestrial transceiver devices, and so forth. Embodiments are not limited to these examples.

In some embodiments, the location device 163 may determine a location of the device 101 and the processor 151 may determine a location confidence value based on one or more factors, such as the manner or sensor in which the location was determined. For example, a location based on GPS may have a higher confidence value. In another example, a location based on IP addressing of the device 101 may have a medium confidence value. In a third example, a location based on a user provided location may have a lower confidence value. The confidence value may be based on a perceived accuracy of the location determined by the location device 163. Further, the processor 151 may include the location and the location confidence value in the one or more text messages communicated to the emergency service provider.

In some embodiments, the location confidence value may include information based on a detected motion of the device 101. The location device 163 or another sensor, such as an accelerometer, may detect the motion of the device 101. A lower confidence value may be provided when the motion is greater than a higher motion threshold value, a medium confidence value may be provide when the motion is between the higher motion threshold value and a lower threshold value, and a higher confidence value may be provide when the motion is lower than the lower threshold value. Note that the confidence value may be based on the both the manner or sensor used to determine the location and the motion of the device 101. Embodiments are not limited in this manner.

Further, the threshold values may be user settings or factory settings set at the time of manufacture. In some instances, the threshold values may be a speed. For example, the higher threshold value may be approximately 10 miles/hour indicating the device 101 is in a car. The lower threshold value may be approximately 3 miles/hour indicating the device 101 is at a walking speed. Embodiments are not limited to these values or examples.

The device 101 may include one or more transceivers 165 coupled with one or more antennas 165 for reception and transmission of information, messages, packets, frames and so forth between other devices. In some embodiments, a transceiver 165 may include a transmitter and a receiver to allow transmission and reception of information and data between the device 101 and a remote location, such as a PSAP 112 via a cellular network 104 and/or an IP network 106. The transmitter and receiver may be combined into the transceiver 165. The antenna(s) 176 may be attached to the device 101 and electrically and communicatively coupled to the transceiver 165. The device 101 may also include (not shown) multiple transmitters, multiple receivers, multiple transceivers, and/or multiple antennas. For example, the device 101 may include a first transceiver capable of communicating via the cellular network 104 and a second transceiver capable of communicating via the IP network 106. Embodiments are not limited in this manner.

In some embodiments, the device 101 and transceiver(s) 165 can communicate in a wireless network or the IP network 106 such as a Local Area Network (LAN), a Wireless LAN (WLAN), a Metropolitan Area Network (MAN), a Wireless MAN (WMAN), a Wide Area Network (WAN), a Wireless WAN (WWAN), devices and/or networks operating in accordance with existing Next Generation mmWave (NGms-D02/r0, Nov. 28, 2008), Wireless Gigabit Alliance (WGA), IEEE 802.11, 802.11a, 802.11b, 802.11e, 802.11g, 802.11 h, 802.11i, 802.11n, 802.11ac, 802.16, 802.16d, 802.16e standards and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Maximum Ratio Combining (MRC) transceiver or device, a transceiver or device having “smart antenna” technology or multiple antenna technology, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDMA, Time-Division Multiplexing (TDM), Time-Division Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), ZigBee™, or the like. Embodiments may be used in various other apparatuses, devices, systems and/or networks.

In embodiments, the device 101 may also include storage 167 capable of storing information and data. By way of example, storage may be disk drives, optical storage devices, solid-state storage device such as a random access memory (“RAM”) and/or a read-only memory (“ROM”), which may be programmable, flash-updateable and/or the like. In embodiments, the storage 167 may store applications 170, an emergency communication component 172, and an operating system (OS) 174 which may be executed by a processor 151 and utilize memory 153 for temporary storage of instructions and data.

In embodiments, the device 101 may include an operating system 174, such as Android®, Apple iOS®, Symbian®, Blackberry OS®, Windows OS®, Palm OS®, and so forth. The operating system 174 may provide an environment and enable other applications, such as messaging application(s) 170 to operate. In embodiments, the messaging application(s) 170 may include any type of messaging application capable of communicating a text message. Specific examples of a messaging application 170 may include “over-the-top” (OTT) message applications or third-party messaging applications that may be downloaded from an application repository, such as Google® Play®. These messaging applications 170 may include Google® Hangouts®, Whatsapp®, Facebook® Messenger®, Viber®, Imo®, Skype®, WeChat®, and so forth. Embodiments are not limited in this manner.

In some instances, the device 101 may include an emergency communications component 172 to assist and cause providing text messages to the emergency service provider 105. The emergency communications component 172 may include a framework implemented in software, hardware, or both to enable a messaging application 170 to communicate a text message to an emergency service provider 105. The framework may include one or more application programming interfaces (APIs) in the form of libraries capable of interfacing with a messaging application 170, the operating system 174, and other components of the device 101. The emergency communication component 172 may perform various functions and operations including receiving a text message from the messaging application 170, determining a network to communicate the text message to an emergency service provider 105, and causing the text message to be communicated to the emergency service provider 105 via the selected network, for example. In some embodiments emergency communication component 172 may include APIs to communicate with other applications and operations processing on the device 101, including one or more operations or processes of the OS 174. For example, the emergency communication component 172 may receive status information about one or more communication connections based on information from the OS 174 and/or other components controlling the transceivers 165.

The emergency communication component 172 may also communicate with other communication operations to perform communication of the text message on the networks. More specifically, the emergency communication component 172 may communicate a text message and/or information to a cellular client operation to cause communication of the message over a cellular connection on a cellular network 104 by the cellular client operation. The cellular client operation may be incorporated or part of a native cellular messaging application or SMS client provided for the device 101. Similarly and in another example, the emergency communication component 172 may communicate the text message and/or information to an IP messaging client operation to cause communication of the message over the IP connection on an IP network 106 by the IP messaging client operation. Similarly, the IP messaging client operation may be incorporated or part of a native IP messaging application. Embodiments are not limited to these examples.

Moreover and in some instances, the emergency communication component 172 may be part of or itself a messaging application. For instances, the emergency communication client component 172 may be a messaging application that is capable of communicating emergency text messages via a cellular network 104 and/or an IP network 106. In these instances, the cellular client operation and/or the IP client operation for communicating the text message may be incorporated or part of the same messaging application as the emergency communication component 172. However, embodiments are not limited in this manner.

In some embodiments, the messaging application(s) 170, emergency communication 172, and the client operations may all be different or part of different messaging applications. In these instances, a messaging application 170 may utilize a messaging application having the emergency communication component 172 to determine an operable network connection and reformat a text message for communication to an emergency service provider 105 based on a selection of an operable network connection. The messaging application including the emergency communication component 172 may then send the text message to a native text messaging application to communicate the text message via the cellular network 104 or IP network 106.

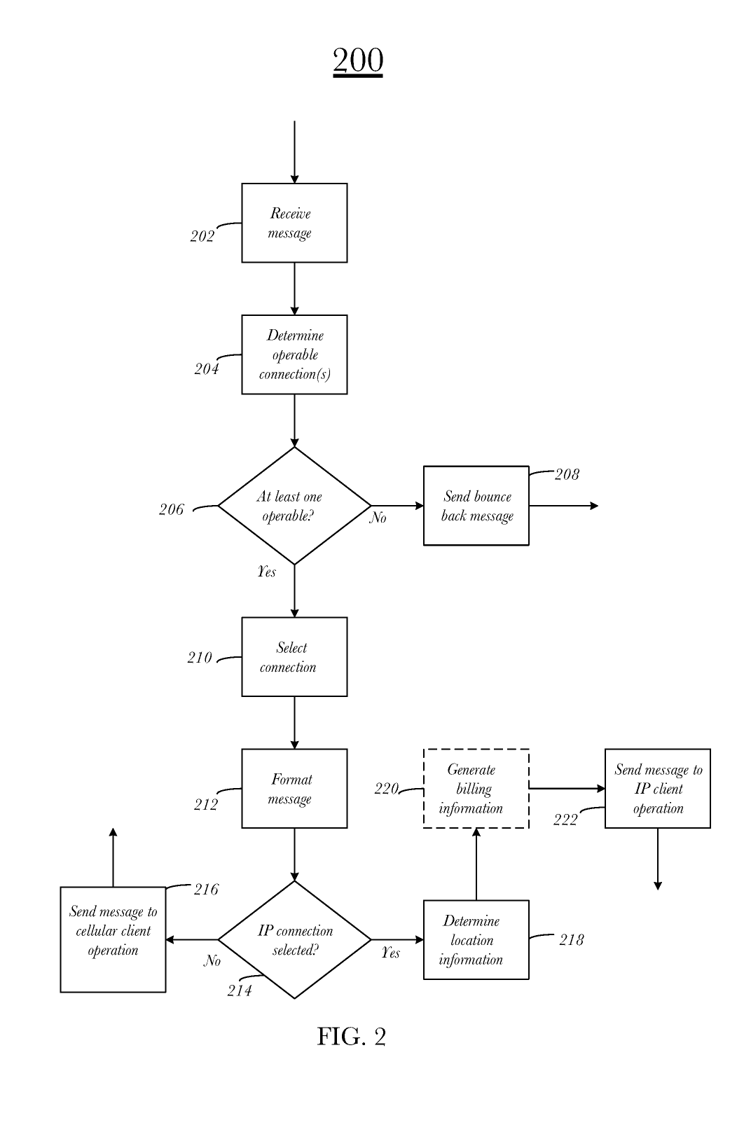

FIG. 2 illustrates one embodiment of a first logic flow 200. The logic flow 200 may be representative of some or all of the operations executed by one or more embodiments described herein. Further, the logic flow 200 may performed by circuitry and one or more components discussed herein, such as the emergency communication component 172. Moreover, logic flow 200 may be performed in conjunction with one or more other logic flows discussed herein and lists particular steps occurring in a particular order.

The logic flow 200 may be one example flow to communicate a text message to an emergency service provider 105. In embodiments, a text message may be received by one or more operations or processes, such as one or more processes of an emergency communication component 172. Note that the text message may be received by the emergency communication component 172 in the form of a notification or indication of the existence of the text message or an identification of one or more storage locations of the text message, and include indication that the text message is destined to go to an emergency service provider 105, for example. The emergency communication component 172 may receive the text message from a messaging application, such as an OTT messaging application, via an API. The text message may be in a standard text message format and may include any combination of alphanumeric characters and symbols. In some embodiments, the text message may be in a format native to a third party application or OTT messaging application which may include a “wrapper” to direct the message to a third-party server for communication. However, these third-party servers generally are not capable of processing messages intended for an emergency service provider 105. Thus, as will discussed in more detail below, the message may be reformatted and communicated via a system that is capable of communicating the message to the emergency service provider 105. Embodiments are not limited in this manner.

At block 204, the emergency communication component 172 may determine whether any communication connections are operable or active on a device 101 to communicate the text message to the emergency service provider 105. This determination may include retrieving information from the operating system 174 and/or one or more transceivers 165. The emergency communication component 172 may determine whether one or more connections exists between the device 101 and one or more networks, e.g. a cellular network 104 and an IP network 106 based on information received from the operating system 174. The determination may be based on whether information is being or is capable of being communicated between the device 101 and the network. Embodiments are not limited in this manner. For example, the determination may be based on a status of the one or more transceivers 165 for communication over the one or more networks. More specifically, the emergency communication component 172 may determine whether a transceiver 165 is active (powered), is coupled with a cellular network 104, and capable of communicating information with the cellular network 104. Similarly, the emergency communication component 172 may determine whether a transceiver 165 is active (powered), is coupled with an IP network 106, and capable of communicating information with the IP network 106. Note that separate transceivers 165 may be used to communicate over the different networks, e.g. cellular network 104 and the IP network 106.

At block decision block 206, the emergency communication component 172 may determine whether at least one connection is operable to communicate with the emergency service provider 105. If no connections are operable at block 206, the emergency communication component 172 may communicate a bounce back message to the messaging application 170, notifying the messaging application 170 that no connections exists and the text message may not be sent. The bounce back message may be communicated via an API and may cause the messaging application 170 to generate a message to alert a user of the device 101. Embodiments are not limited in this manner.

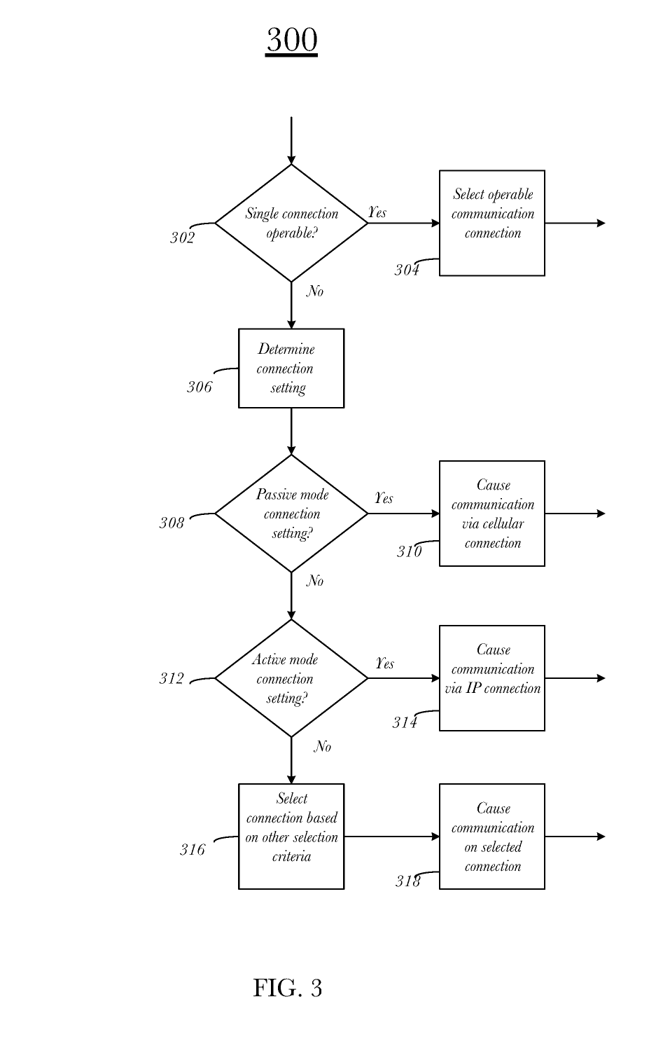

If at least one connection is operable at block 206, the emergency communication component 172 may select a connection to communicate the text message to an emergency service provider 105 based on a selection criteria, as will be discussed in more detail below in FIG. 3. The selection of a connection may include selecting a specific network, such as the cellular network 104 and the IP network 106, and a transceiver 165 associated with the specific network to communicate the text message.

At block 208, the emergency communication component 172 may include formatting or reformatting the text message for communication to the emergency service provider 105. The format may include removing the “wrapper” generally used to communicate the message to a third-party server and generate a new message or recompose the current message in a new format based on the network selected. For example, the emergency communication component 172 may format and/or recompose the text message including the text of the message itself into a text message format capable of being communicated over cellular network 104. More specifically, the message may be formatted to communicate in accordance with a short message service (SMS) protocol or a multimedia messaging service (MMS) protocol and may include an indication that the message is a SMS or MMS message, sender meta-data, receiving meta-data, and a time stamp. Further, the message may be formatted into a SMS or MMS protocol data unit (PDU) capable of being communicated over the cellular network 104, for example.

In another example, the emergency communication component 172 may format and/or recompose the message into an instant message or packetized format capable of being communicated over an IP network 106. More specifically, the message may be formatted to communicate via transmission control protocol/internet protocol (TCP/IP) at the transport layer and in accordance with a middleware format, such as the Extensible Messaging and Presence Protocol (XMPP) at the application layer. The text message may be broken into one or more packets which may include a header including source information and destination information, and data including the text of the message. Further, information may be generated in a header or wrapper to communicate the message to a server that is capable of processing the message and sending it to the appropriate emergency service provider 105 and PSAP 112, e.g. the IP service provider system 108 that is capable of determining a location associated with the message and a correct PSAP 112 based on the location. In other words, the wrapper to communicate the message to the third-party server may be removed and a different or new wrapper may be applied to direct the message to a server capable directing the message to an emergency service provider 105. Note that the protocol selected and applied to the message may be specified by the IP service provider system 108 and embodiments are not limited in this manner.

At decision block 214, the emergency connection component 170 may determine whether the message is to be communicated via an IP connection over the IP network 106. Note that the opposite determination and logic may be used with respect to this block. For example, the emergency connection component 170 may determine whether the message is to be communicated via a cellular connection over the cellular network 104. Embodiments are not limited in this manner.

If the message is to be directed to a cellular connection at block 214, the emergency communication component 172 may communicate the message (or an indication of the message) to a cellular client operation capable of communicating the message over the cellular connection and on the cellular network 104 at block 216. In some embodiments, the cellular client operation may be part of a native SMS or MMS client for the device 101. In other embodiments, the cellular client operation may be included with or part of the emergency communication component 172. Embodiments are not limited in this manner. For example, the cellular client operation may be part of a different third-party application capable of communicating a message via the cellular connection over the cellular network 104 to an emergency service provider 105. In any case, the message may be communicated to the cellular client operation which may further communicate the message via the cellular connection (and associated transceiver 165) and to the cellular network 104 to the emergency service provider 105. Note, and although not shown, the cellular client operation may communicate location information and a location confidence value with the text message sent via the cellular network 104. In some instances, the location information and location confidence value may be, at least in part, determined by the emergency communication component 172.

If the message is to be directed to an IP connection at block 214, at block 218 the emergency communication component 172 may determine location information to communicate as part of the message or in different messages (packets) having identifying information to associate the location information with the message. The location information may be determined by the location device 163 and provided to the emergency communication component 172. For example, the location device 163 may determine the location of the device 101 based on GPS signals, triangulation, wi-fi access point location, and so forth. In some embodiments, the location information may be retrieved by the location device 163 from a remote server and may be based on a connection with an access point or a cellular tower. In some instances, the emergency communication component 172 may determine a location confidence value associated with the text message based on the location information and motion of the device 101. The location confidence value may also be communicated to the emergency service provider 105 via the IP network 106.

At block 220, billing information may be generated by the emergency communication component 172 to bill an originating messaging application, e.g. third-party message or OTT messaging application, for the use of the IP service provider system 108 to communicate and direct the message to the PSAP 112 for the message. These services may be provided by the emergency communication component 172 framework such that a third-party messaging application may remain compliant with the rules and regulations established for emergency services set out by the Federal Communications Commission (FCC) without having to generate logic and processing capabilities themselves. The billing information may include a message application identifier to identify the originating messaging application, a date and time for the message, a location for the message, and a user identifier to identifying the device from which the message was communicated. Embodiments are not limited in the manner and the billing information may include other information.

At block 222, the emergency communication component 172 may communicate the message (or indication of the message) to an IP messaging client operation capable of communicating the message over the IP connection and on the IP network 106. In some embodiments, the IP messaging client operation may be part of a native IP client for the device 101. In other embodiments, the IP messaging client operation may be included with or part of the emergency communication component 172. Embodiments are not limited in this manner. For example, the IP messaging client operation may be part of a native IP messaging client capable of communicating a message via the IP connection over the IP network 106 to an emergency service provider 105. Embodiments are not limited in this manner.

FIG. 3 illustrates example embodiment of a second logic flow 300. The logic flow 300 may be representative of some or all of the operations executed by one or more embodiments described herein. Further, the logic flow 300 may performed by circuitry and one or more components discussed herein, such as the emergency communication component 172. Moreover, logic flow 300 may be performed in conjunction with one or more other logic flows discussed herein.

The logic flow 300 may be one example processing flow to select the appropriate connection to communicate the message to the emergency service provider 105. As mentioned, the emergency communication component 172 may select a connection based on selection criteria including connection availability, connection priority, connection setting(s), and connection strength. The connection availability may indicate whether one or more connections are available to communicate the message. For instances, if only a single connection is available, the available connection will be used to communicate the message. The connection priority may indicate a preference or a priority assigned to a specific connection. For instances, a higher priority may be assigned to a cellular connection and a lower priority may be assigned to an IP connection, or vice versa. The priorities for each connection may be a user setting, a factory setting, a default setting, and so forth. Embodiments are not limited in this manner.

In some embodiments, a user or the originating messaging application may determine or set a communication setting, mode or preference for communicating the message to the emergency service provider 105. For example, embodiments may include having a passive connection setting to always communicate the message via the cellular connection using a cellular client operation unless the cellular connection is unavailable. In another example, embodiments may include having an active connection setting that a message is communicated via an IP connection using an IP messaging client operation to communicate with the IP service provider system 108 unless an IP connection is not available. In a third example, embodiments may include having an auto communication setting such that the message is communicated based on other selection criteria, e.g. connection priority and connection strength. The connection strength may be a signal strength and may be based on a communication power requirement to communicate with a network. Embodiments are not limited in this manner. These and other details will become more apparent in the following description of logic flow 300.

At block 302, the emergency communication component 172 may determine whether one or more connections are operable on the device 101. For example, the emergency communication component 172 may determine whether one or more connections exists between the device 101 and one or more networks, e.g. a cellular network 104 and an IP network 106. The determination may be based on whether information is being or is capable of being communicated between the device 101 and a network. Embodiments are not limited in this manner. For example, the determination may be based on a status of one or more transceivers 165 for communication over the one or more networks. More specifically, the emergency communication component 172 may determine whether a transceiver 165 is active (powered), is coupled with a cellular network 104, and capable of communicating information with the cellular network 104. Similarly, the emergency communication component 172 may determine whether a transceiver 165 is active (powered), is coupled with an IP network 106, and capable of communicating information with the IP network 106. Note that separate transceivers 165 may be used to communicate over the different networks, e.g. cellular network 104 and the IP network 106. Embodiments are not limited in this manner.

If only one connection is operable at block 302, the emergency communication component 172 may select the operable communication connection to communicate the message to the emergency service provider 105. If more than one connection is operable and available at block 302, the emergency communication component 172 may determine one or more connection settings for the originating messaging application and/or user defined settings at block 306. As mentioned, the connection setting may be a passive mode connection setting to cause communicating via a cellular connection, an active mode connection setting to cause communicating via an IP connection, and an auto connection setting to cause communicating via a connection based on other selection criteria, e.g. priority and connection strength.

More specifically and at block 308, the emergency communication component 172 may determine if the connection setting is passive and select the cellular connection to cause communication via the cellular connection at block 310. Further, if the connection setting is active at determination block 312, the emergency communication component 172 may select the IP connection and cause communication of the message via the IP connection at block 314. Further still, if the connection setting is set to auto and/or no connection setting is set, the emergency communication component 172 may select the connection to communicate the message based on other selection criteria at block 316. For example, if a priority level is selected for the connection, the emergency communication component 172 may select the connection having the highest priority level to communicate the message. In another example, the emergency communication component 172 may select the connection having the best communication or strongest signal strength to communicate the message. At block 318, the emergency connection component 172 may select a connection and cause communication via the selected communication as previously discussed in FIG. 2. Embodiments are not limited in this manner.

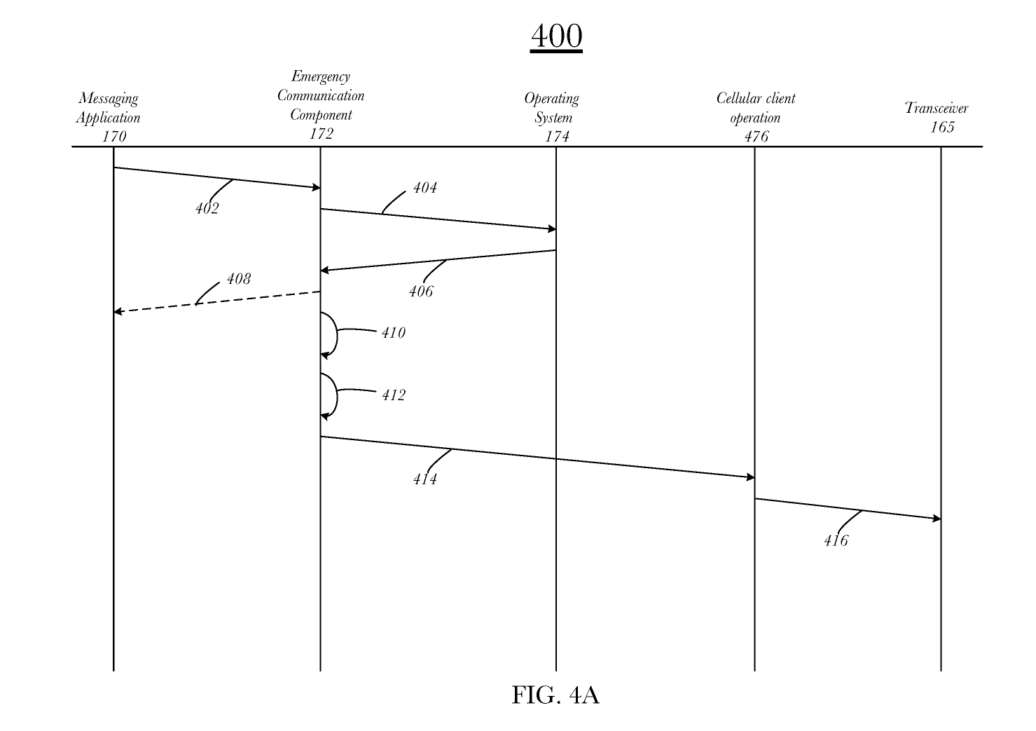

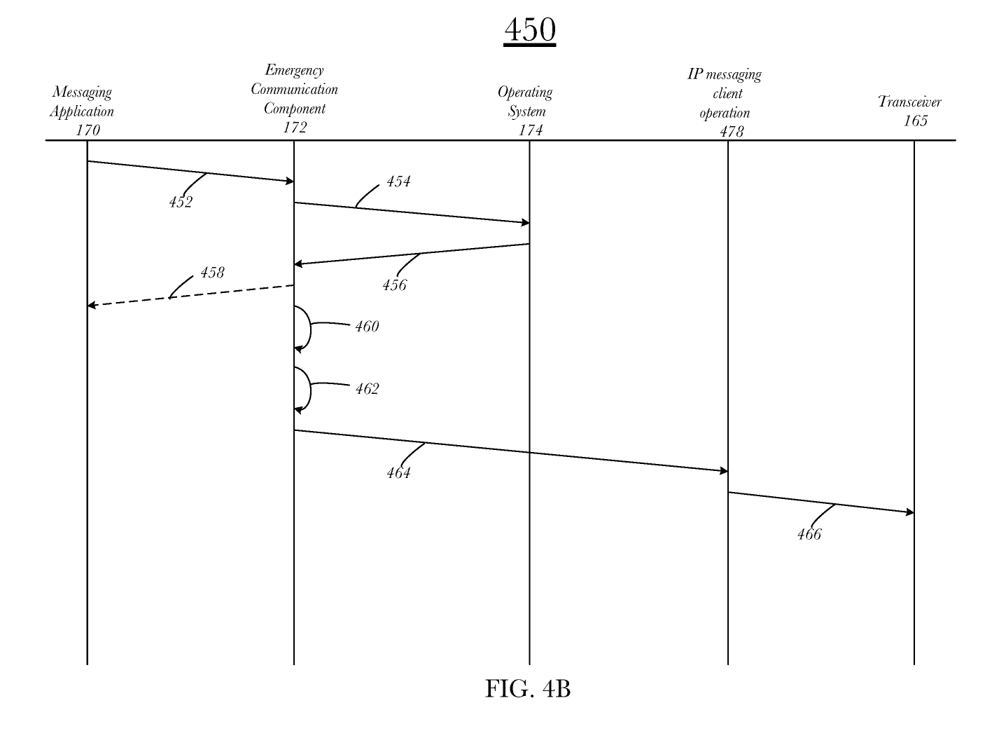

FIG. 4A illustrates an example of a first processing flow 400 to communicate a message via a cellular connection to an emergency service provider 105. Although processing flow 400 illustrates certain processes occurring in a particular order, embodiments are not limited in this manner. One or more processes may occur before, after, or at the same time as other processes. Moreover, processing flow 400 may be performed in conjunction with one or more other processing flows and logic flows discussed herein.

At line 402, a messaging application 170, such as an OTT messaging application or a third-party messaging application, may communicate a message to the emergency communication component 172. In some instances, the messaging application 170 may communicate the message via an API in the form of an indication or notification that the message is to be sent to an emergency service provider 105. Embodiments are not limited in this manner. At line 404, the emergency communication component 172 may determine whether one or more communication connections are operable on the device 101. In some embodiments, the emergency communication component 172 may communicate with the operating system 174 and/or transceivers 165 (not shown) to determine which communication connections are operable. More specifically, the emergency communication component 172 may communicate a request for information to the operating system 174. Requested information may include indication of active connections, whether one or more transceivers are operable (powered), connection information indicating which communication connections are communicating data, and so forth. The request may be communicated to the operating system 174 as one or more instructions or messages. However, embodiments are not limited in this manner.

At line 406, the emergency communication component 172 may receive a response to the request and/or information indicating which, if any, communication connections are operable. The response and information may indicate whether one or connections exists between the device 101 and one or more networks, e.g. a cellular network 104 and an IP network 106. In some instances, the response and information may indicate whether information is being or is capable of being communicated between the device 101 and a network, for example. In some instances, the response and information may indicate a status of one or more transceivers 165 for communication over the one or more networks. More specifically, the emergency communication component 172 may determine whether a transceiver 165 is active (powered), is coupled with a cellular network 104, and capable of communicating information with the cellular network 104. Similarly, the emergency communication component 172 may determine whether a transceiver 165 is active (powered), is coupled with an IP network 106, and capable of communicating information with the IP network 106. Note that separate transceivers 165 may be used to communicate over the different networks, e.g. cellular network 104 and the IP network 106.

At optional line 408, the emergency communication component 172 may communicate a bounce back message if no communication connections are operable on the device 101. If this is the case, the processing flow 400 may cease. However, if one or more communication connections are operable, the emergency communication component 172 may select a connection at line 410 and format or reformat the message based on the selection at line 412, as previously discussed above in FIGS. 2 and 3.

In this example processing flow 400, the emergency communication component 172 may have selected a cellular connection to communicate the message and formatted the message accordingly. At line 414, the emergency communication component 172 may send the message to a cellular client operation 476 for communication by a transceiver 165 at line 416. The message may be communicated to the cellular client operation 476 via one or more instructions and an API, as previously discussed above in FIGS. 2 and 3. For example, in some instances, the cellular client operation 476 may be an operation of a native SMS client application capable of communicating text messages to an emergency service provider 105. However, embodiments are not limited in this manner. At line 416, the transceiver 165 may receive the message and communicate via a cellular network 104.

FIG. 4B illustrates an example of a first processing flow 450 to communicate a message via an IP connection to an emergency service provider 105. Although processing flow 450 illustrates certain processes occurring in a particular order, embodiments are not limited in this manner. One or more processes may occur before, after, or at the same time as other processes. Moreover, processing flow 450 may be performed in conjunction with one or more other processing flows discussed herein.

At line 452, a messaging application 170, such as an OTT messaging application or a third-party messaging application, may communicate a message to the emergency communication component 172. At line 454, the emergency communication component 172 may determine whether one or more communication connections are operable on the device. In some embodiments, the emergency communication component 172 may communicate with the operating system 174 and/or transceivers 165 (not shown) to determine which communication connections are operable, if any. For example, the emergency communication component 172 may communicate a request for information, such as active connections, status of transceivers, connection information, and so forth. The request may be communicated to the operating system 174 and/or transceivers 165 or controllers thereof as one or more instructions via an API, for example. However, embodiments are not limited in this manner.

At line 456, the emergency communication component 172 may receive a response to the request and/or information indicating which, if any, communication connections are operable. The response and information may indicate whether one or connections exists between the device 101 and one or more networks, e.g. a cellular network 104 and an IP network 106. In some instances, the response and information may indicate whether information is being or is capable of being communicated between the device 101 and a network, for example. In some instances, the response and information may indicate a status of one or more transceivers 165 for communication over the one or more networks. More specifically, the emergency communication component 172 may determine whether a transceiver 165 is active (powered), is coupled with a cellular network 104, and capable of communicating information with the cellular network 104. Similarly, the emergency communication component 172 may determine whether a transceiver 165 is active (powered), is coupled with an IP network 106, and capable of communicating information with the IP network 106. Note that separate transceivers 165 may be used to communicate over the different networks, e.g. cellular network 104 and the IP network 106.

At optional line 458, the emergency communication component 172 may communicate a bounce back message if no communication connections are operable on the device 101. If this is the case, the processing flow 450 may cease. However, if one or more communication connections are operable, the emergency communication component 172 may select a connection at line 460 and format the message based on the selection at line 462, as previously discussed above in FIGS. 2 and 3.

In this example processing flow 450, the emergency communication component 172 may have selected an IP connection to communicate the message and formatted the message accordingly. At line 464, the emergency communication component 172 may send the message to an IP messaging client operation 478 for communication by a transceiver 165 at line 466. The message may be communicated to the IP messaging client operation 476 via one or more instructions and an API, as previously discussed above in FIGS. 2 and 3. In some instances, the IP messaging client operation 478 may be part of a native IP messaging application capable of communicating text messages to an emergency service provider 105. However, embodiments are not limited in this manner. At line 466, the transceiver 165 may receive the message and communicate the message via an IP network 106, for example.

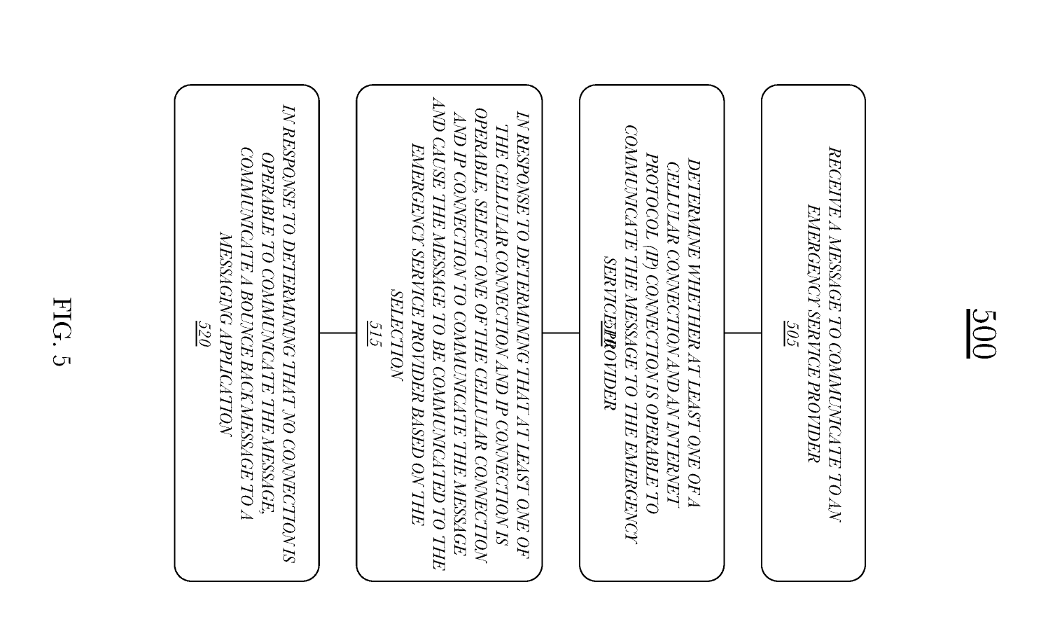

FIG. 5 illustrates an example embodiment of a third logic flow 500. The logic flow 500 may be representative of some or all of the operations executed by one or more embodiments described herein. For example, the logic flow 500 may illustrate operations performed by systems 100 and 150 and device 101. In the illustrated embodiment shown in FIG. 5, the logic flow 500 may include receiving a message to communicate to an emergency service provider at block 505. The message may be received as one or more a notification of the message and an indication that the message is to be communicated to an emergency service provider. In some instances, the message may be received from a third-party or OTT messaging application; however embodiments are not limited in this manner and the message may be received from a native messaging application.

At block 510, the logic flow 500 may include determining whether at least one of a cellular connection and an Internet Protocol (IP) connection is operable to communicate the message to the emergency service provider. For example, embodiments may include retrieving information from one or more of an operating system and transceivers to determine a status of transceivers and network connections.

The logic flow 500 may include, in response to determining that at least one of the cellular connection and IP connection is operable, selecting one of the cellular connection and IP connection to communicate the message and cause the message to be communicated to the emergency service provider based on the selection at block 515. As previously discussed the selection may be based on one or more selection criteria and the message may be communicated by a client operation capable of communicating on the selected network.

In some embodiments, the logic 500 may include, in response to determining that no connection is operable to communicate the message, communicating a bounce back message to a messaging application at block 520. The bounce back message may indicate to the originating messaging application that the message cannot be communicated to an emergency service provider because no connections are operable. In some embodiments, the bounce back message may cause a notification to be communicated to a user of the device.

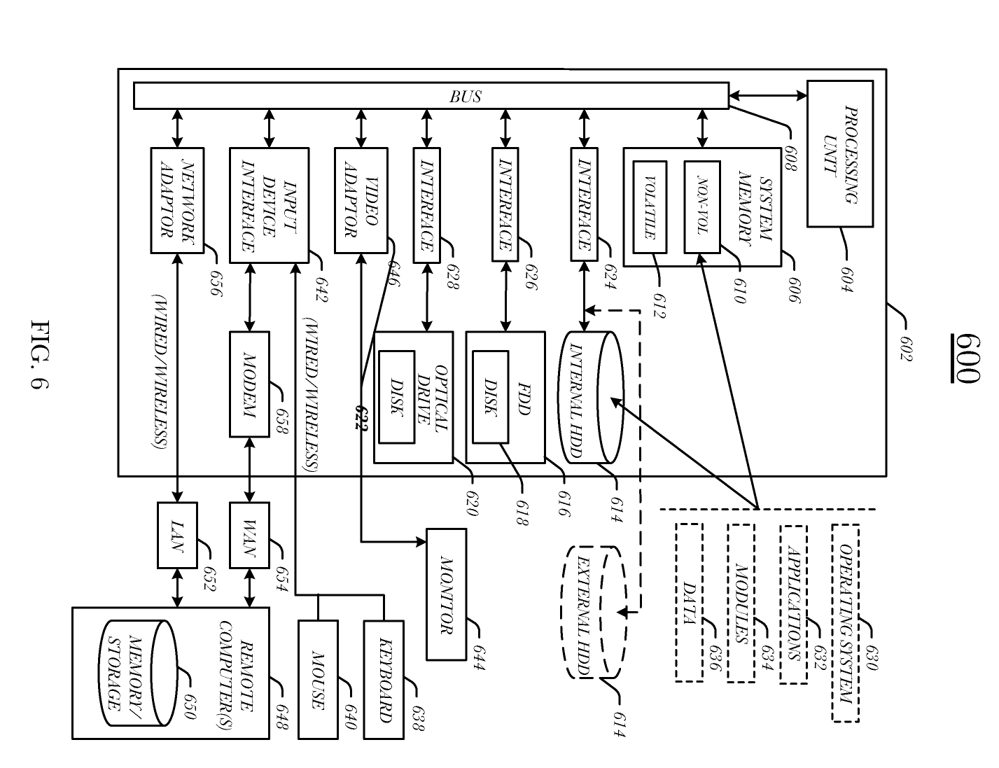

FIG. 6 illustrates an embodiment of an exemplary computing architecture 600 suitable for implementing various embodiments as previously described. In one embodiment, the computing architecture 600 may include or be implemented as part of one or more systems and devices discussed herein such as device 101.

As used in this application, the terms “system” and “component” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 600 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include, for example, the various applications and/or components of the system 100.

A user can enter commands and information into the computer 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 604 through an input device interface 642 that is coupled to the system bus 608, but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
memory;
logic, at least a portion of which is implemented in circuitry coupled to the memory, the logic to:
receive a message to communicate to an emergency service provider from a first messaging application that is not capable of communicating with the emergency service provider;
determine whether at least one of a cellular connection and an Internet Protocol (IP) connection is operable to communicate the message to the emergency service provider;
in response to determining that at least one of the cellular connection and IP connection is operable, select one of the cellular connection and IP connection to communicate the message, format the message to be compatible for communication via a second messaging application based on the selection, and cause the message to be communicated to the emergency service provider via the second messaging application; and
in response to determining that no connection is operable to communicate the message, communicate a bounce back message to the first messaging application.

2. The apparatus of claim 1, the format comprising a text message format to communicate the message over the cellular connection and the logic to send the message to a cellular client operation of the second messaging application to cause the communication to the emergency service provider.

3. The apparatus of claim 1, the format comprising an instant message format to communicate the message over the IP connection and the logic to send the message to an IP messaging client operation of the second messaging application to cause the communication to the emergency service provider.

4. The apparatus of claim 1, the logic to select one of the cellular connection and IP connection based on a selection criteria comprising one or more of a connection availability, a connection priority, a connection setting, and a connection strength.

5. The apparatus of claim 1, the logic to receive the message from the first message application via an application programming interface (API).

6. The apparatus of claim 1, the logic to generate billing information when the IP connection is used to communicate the message, the billing information comprising at least one of a message application identifier, a date and time for the message, a location for the message, and a user identifier.

7. The apparatus of claim 1, the logic to include location information with the message for communication utilizing the IP connection, the location information comprising at least one of a global position system (GPS) location, a triangulation location, user input location, and an access point location.

8. The apparatus of claim 1, comprising:
a first transceiver comprising circuitry capable of establishing the cellular connection and communicating with the emergency service provider via a cellular network; and
a second transceiver comprising circuitry capable of establishing the IP connection and communicating with the emergency service provider via an IP network.

9. A non-transitory computer-readable storage medium comprising a plurality of instructions that when executed enable processing circuitry to:
receive a message to communicate to an emergency service provider from a first messaging application that is not capable of communicating with the emergency service provider;
determine whether at least one of a cellular connection and an Internet Protocol (IP) connection is operable to communicate the message to the emergency service provider;
in response to determining that at least one of the cellular connection and IP connection is operable, select one of the cellular connection and IP connection to communicate the message, format the message to be compatible for communication via a second messaging application based on the selection, and cause the message to be communicated to the emergency service provider via the second messaging application; and
in response to determining that no connection is operable to communicate the message, communicate a bounce back message to the first messaging application.

9. The non-transitory computer-readable storage medium of claim 9, the format comprising a text message format to communicate the message over the cellular connection and the logic to send the message to a cellular client operation of the second messaging application to cause the communication to the emergency service provider.

10. The non-transitory computer-readable storage medium of claim 9, the format comprising an instant message format to communicate the message over the IP connection and the logic to send the message to an IP messaging client operation of the second messaging application to cause the communication to the emergency service provider.

11. The non-transitory computer-readable storage medium of claim 9, comprising the plurality of instructions that when executed enable the processing circuitry to select one of the cellular connection and IP connection based on a selection criteria comprising one or more of a connection availability, a connection priority, a connection setting, and a connection strength.

12. The non-transitory computer-readable storage medium of claim 9, comprising the plurality of instructions that when executed enable the processing circuitry to receive the message from the first message application via an application programming interface (API).

13. The non-transitory computer-readable storage medium of claim 9, comprising the plurality of instructions that when executed enable the processing circuitry to generate billing information if the IP connection is used to communicate the message, the billing information comprising at least one of a message application identifier, a date and time for the message, a location for the message, and a user identifier.

14. The non-transitory computer-readable storage medium of claim 9, comprising the plurality of instructions that when executed enable the processing circuitry to include location information with the message for communication utilizing the IP connection, the location information comprising at least one of a global position system (GPS) location, a triangulation location, user input location, and an access point location.

15. A computer-implemented method, comprising:
receiving a message to communicate to an emergency service provider from a first messaging application that is not capable of communicating with the emergency service provider;
determining whether at least one of a cellular connection and an Internet Protocol (IP) connection is operable to communicate the message to the emergency service provider;
in response to determining that at least one of the cellular connection and IP connection is operable, selecting one of the cellular connection and IP connection to communicate the message, formatting the message to be compatible for communication via a second messaging application based on the selection, and causing the message to be communicated to the emergency service provider via the second messaging application; and
in response to determining that no connection is operable to communicate the message, communicating a bounce back message to the first messaging application.

16. The computer-implemented method of claim 15, comprising sending the message to a cellular client operation of the second messaging application to cause the communication, the message sent in the format comprising a text message format to communicate the message over the cellular connection to the emergency service provider.

17. The computer-implemented method of claim 15, comprising sending the message to an IP messaging client operation of the second messaging application to cause the communication, the message in the format comprising an instant message format to communicate the message over the IP connection to the emergency service provider.

18. The computer-implemented method of claim 15, comprising selecting one of the cellular connection and IP connection based on a selection criteria comprising one or more of a connection availability, a connection priority, a connection setting, and a connection strength.

19. The computer-implemented method of claim 15, comprising receiving the message from the first message application via an application programming interface (API).

20. The computer-implemented method of claim 15, comprising generating billing information if the IP connection is used to communicate the message, the billing information comprising at least one of a message application identifier, a date and time for the message, a location for the message, and a user identifier.

21. The computer-implemented method of claim 15, comprising including location information with the message for communication utilizing the IP connection, the location information comprising at least one of a global position system (GPS) location, a triangulation location, user input location, and an access point location.
